(19) United States
(12) Patent Application Publication
(10) Pub. No.: US 2006/0283562 A1
(43) Pub. Date: Dec. 21, 2006

(54) Dust protection door

(76) Inventor: Stephen Paul Hickey, Reepham (GB)

Correspondence Address: STEPHEN PAUL HICKEY, 57 MILL ROAD, BLOFIELD HEATH, NORWICH, ENG, NR 13 4QS, GB

(21) Appl. No.: 11/154,551

(22) Filed: Jun. 17, 2005

(51) Int. Cl. E06B 7/28

(52) U.S. Cl. 160/180

(57) ABSTRACT

A detachable dust-impermeable material based screen with a resealable rolled door access panel with zip openings and hooks & loop panels which can be secured to standard internal and external household doors or similar building apertures to prevent dust transfers from room to room. Preferably the invention is made from fabrics or plastic and is secured to a door surround with adhesive tape or alike which seals and also prevents dust contamination.

### CROSS-REFERENCE TO RELATED APPLICATIONS

United States patent;—Panttila U.S. Pat. No. 4,909,004. Mar. 20, 1990

United States patent;—Saulters U.S. Pat. No. 5,427,169. Jun. 27, 1995

United States patent;—Shelton U.S. Pat. No. 4,100,957. Jul. 18, 1978

United States patent;—Antinone U.S. Pat. No. 3,763,917. Oct. 9, 1973

United States patent;—Grossman U.S. Pat. No. 3,251,399 May. 17, 1966

United States patent;—Melino U.S. Pat. No. 4,794,974 Jan. 3, 1989

United States patent;—Brophy U.S. Pat. No. 5,345,989 Sep. 13, 1994

UK Patent application;—Veen GB 2 360452 A Sep. 26, 2001

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APENDIX

Not applicable

### BACKGROUND OF THE INVENTION

This invention relates to a detachable dust screen for door surrounds or similar building apertures to prevent unwanted dust transfer during construction and DIY home improvements.

In the past, sealed door screens with stowed resealable entry and exit door access panels have not been available for the prevention of room to room dust contamination and pollution during building DIY and home improvements or where a door has been removed or is yet to be fitted.

Previous prior art United States patents;—Panttila U.S. Pat. Nos. 4,909,004, Saulters 5,427,169, Shelton 4,100,957, Antinone 3,763,917, Grossman 3,251,399 show flexible mesh screens have been invented for garages windows and vans however these inventions have concentrated on pest or insect prevention and storm protection and the inventions do not offer a solution capable of preventing dust contamination between rooms. Although a skilled person may consider previous solutions provided for the prevention of other airborne entities and choose to remanufacture the prior art with a change of materials, none of the solutions offer an invention capable for preventing room to room dust transfer or beyond a basic level of protection and none offer a secured and sealed solution during entry and exit.

Prior United States patents Melino U.S. Pat. Nos. 4,794,974, Brophy 5,345,989 and UK cited Patent application;—Veen GB 2 360452 A, have tackled the problem of dust transfer with Melino U.S. Pat. Nos. 4,794,974 and Brophy 5,345,989 offering Curtain wall solutions with Brophy U.S. Pat. No. 5,345,989 offering that a zipper maybe provided for a slit in the middle of the curtain for access. A single zipped access solution is also offered by Veen GB 2360452 A, however both inventions provide the user with awkward access for larger units and general access and neither provide a solution of secured complete seal to all sides of the surrounds whilst maintaining walk through access together with apparatus to store and retain the door panel when in use and none of the above cited references offer a combination of differing and varying levels of access.

In view of the above, the present inventions objective and purpose is to provide a detachable sealed environment solution to prevent dust transfer from room to room in addition to maintaining the ready secured seal during entry and exit with the maximum unhindered space made available to the user for access there through.

### BRIEF SUMMARY OF THE INVENTION

The object of this invention is to provide a detachable dust screen for door surrounds or similar building apertures to prevent unwanted room to room dust transfer during construction and DIY home improvements. To achieve the objections of the invention, the invention comprises of a detachable flexible dust-impermeable material screen with dimensions similar to standard door apertures. An aperture is manufactured into the screen to house an overlapping door access panel which is manufactured and sewn to the screen along the access panel's top edge. The dimensions of the door access panel also mirror the proportionate dimensions of standard door apertures allowing for maximum access space for entry and exit.

The first lower edge of the door panel overlaps the base of the screen with a sewn sealing panel which is releasably attached to an adjacent part of the screen material with hook and loop fastenings. The perpendicular remaining edges of the access panel are provided with double sided zip fastenings which are releasably attached to adjacent parts of the screen material creating a dust proof seal when all fastenings are fastened. The use of a combination of fastenings allows for quick access and also various combinations of full and restricted access. The invention offers eight variations of access with differing zip and hook and loop combinations.

The invention also provides a mechanism for storing and suspending the rolled door access panel whilst in use by releasing the fastenings and storing the rolled door above the entry and exit thoroughfare. Straps are provided on the rear of the screen which are sufficient to encompass the rolled access panel and locate through material loops sewn on the front of the screen above the rolled access panel. The straps are provided with hook and loop tabs which attach to complimentary parts on the straps to form a securing attachment sufficient to retain the weight of the access door in position. The mechanism is designed for fast simple use with sufficient strength to be reliable in the working environment. The peripheral edge of the screen provides a hemmed edge which also guides the adhesive tape overlap attachment to the surround with the base of the screen also providing a sewn panel which lays flush with the base of the surround and is secured with adhesive tape overlap creating an all-round seal to the surround. The invention is not only sealed to prevent contamination, the ready seal prevents continual resealing the screen each time it is used for entry or exit.

### BRIEF DESCRIPTION OF SEVERAL VIEWS OF THE DRAWING

FIG. 1. Depicts a front view of the dust protection door sealed to the surround with the door access panel rolled and stowed for entry and exit access.

FIG. 2. Depicts a closer view of the retaining strap mechanism to stow and retain the rolled access door panel in its open mode.

FIG. 3. Depicts the base of the dust protection door in its open mode allowing entry and exit whilst maintaining a seal at the base of the surround.

FIG. 4. Depicts a front view the dust protection door in closed mode with the zip fasteners and hook and loop fastenings sealed to prevent dust contamination in adjoining rooms.

FIG. 5. Depicts a rear view of the dust protection door in closed mode with zip fasteners and hook and loop fastenings sealed to prevent dust contamination in adjoining rooms.

FIG. 6. Depicts close up front view of the base of the dust protection door and its sealing panel in closed mode.

### DETAILED DESCRIPTION OF THE INVENTION

The invention relates to a detachable fabric or plastic dust impermeable material based door screen with a resealable door panel employing zip fastenings and hooks & loop panels which can be secured to standard internal and external doors or similar building aperture to prevent dust transfers from room to room. The invention is preferably secured to a door surround with adhesive tape or alike which is suitable to seal and prevent dust transfer.

The object of the invention is to provide easy access in and out of a working environment with a secure dust prevention defence still intact and which offers eight variations of access by employing different combination use of the fastenings.

A preferred embodiment of the invention will now be described with reference more particularly to the drawings:

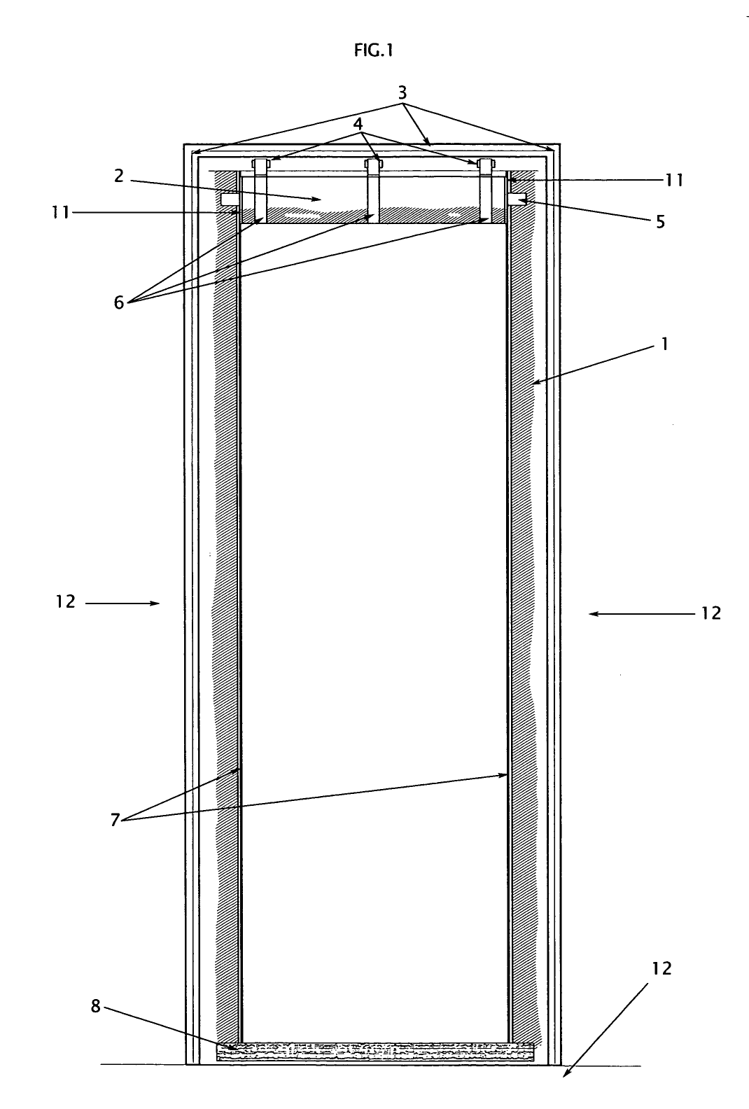

FIG. 1 depicts a preferred embodiment of the invention and a front view of the dust protection door sealed to the surround with the door access panel rolled in its open mode permitting entry and exit there through. The screen being depicted 1 with the rolled access panel depicted 2. The screen and access panel being made from dust impermeable fabric or plastic material, or a combination to these materials. Around the hemmed peripheral edges of the screen is depicted an overlap aligned with the screens peripheral hem of adhesive tape 3 of sufficient quality to form a dust proof seal along the peripheral edges of the screen to all sides of the surrounds 12. FIG. 1 also depicts the rolled door access panel suspended and secured by a plurality of straps 6 which are looped through a retaining tab apparatus 4 sewn onto the screen which retain the weight of the door access panel when secured by hook and loop attachments sewn on the straps and attached to each others complimentary parts. Along the perpendicular inner edges of the screen are depicted double sided zip fastenings 7 of which the complimentary parts of the zip are depicted rolled 11 and being sewn to the access panel 2. Double sided zippers are used in order that the access panel can be opened from either side. FIG. 1 also depicts the overlapping sealing panel 5 on the base of the door access panel 2 suspended and stowed with the rolled access panel. The sealing panel being sewn to the base of the access panel and including complimentary parts of hook and loop fastenings which form a seal with hook and loop fastenings at the base of the screen 8 when in closed mode.

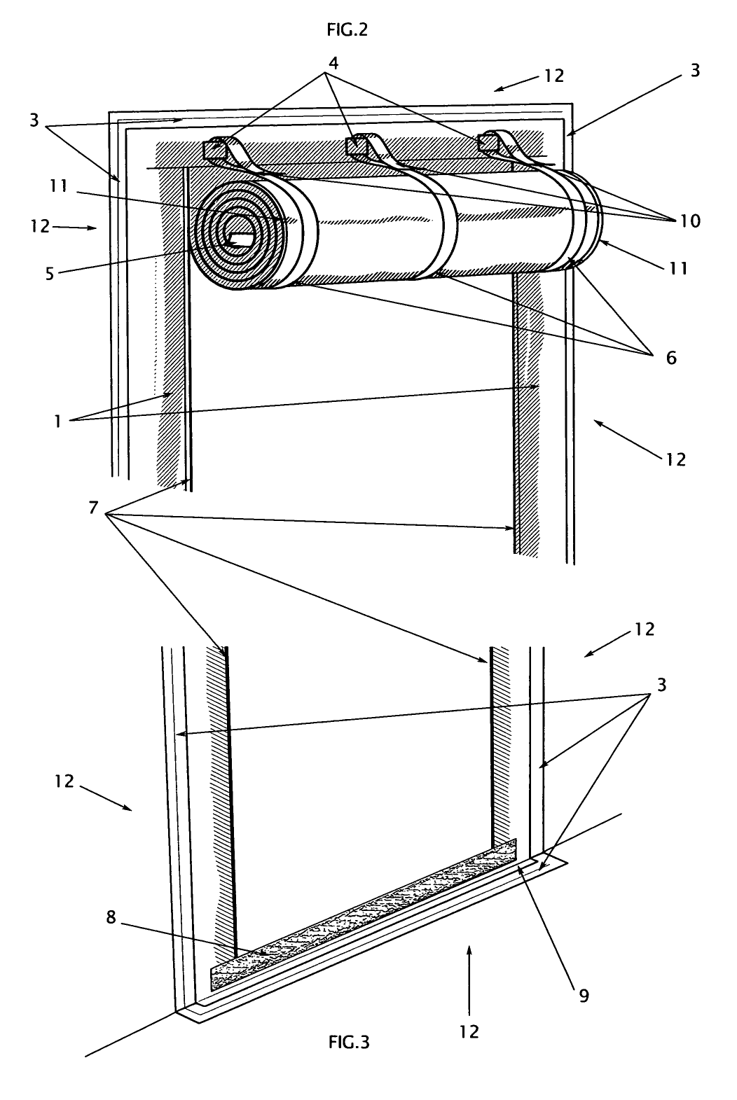

FIG. 2. Depicts a closer view of the retaining strap mechanism to stow and retain the rolled access door panel in its open mode. The drawing depicts the dust protection door sealed to the surround with the door access panel rolled for entry and exit there through. The screen being depicted 1 with the rolled access panel depicted 2. Around the hemmed peripheral edges of the screen is depicted adhesive tape 3 overlap aligned with the screens peripheral hem forming a seal to the surrounds 12. The drawing also discloses in more detail the rolled door access panel secured with a plurality of straps 6 which are looped through the retaining tabs sewn onto the screen 4. The Strap mechanism also depicts the straps forming an attachment to themselves by use of hook and loop tabs sewn into the straps 10 which retain the weight of the rolled access panel. Along the perpendicular inner edges of the screen are depicted double sided zip fastenings 7 of which the complimentary parts of the zip are depicted rolled 11 as they are sewn to the access panel 2. FIG. 2 also depicts the overlapping sealing panel 5 on the base of the access panel 2 as suspended rolled and stowed with the rolled access panel. The sealing panel being sewn to the base of the access panel and including complimentary parts of a hook and loop fastenings for attachment to the base of the screen.

Referring to FIG. 3. The drawing depicts a closer view of the base of the dust protection door in its open mode maintaining a seal at the base of the surrounds 12 whilst in use. The screen being depicted 1 with the base of the screens folded hem depicted 9. The drawing discloses when 9 is folded along its second hem for its intended purpose, the base of the screen provides a sealing panel which lays flush with the base of the surround 12 and is secured with a adhesive tape 3 overlap aligned with the screens peripheral hem. The perpendicular inner edges of the screen are also depicted with double sided zip fastenings 7 together with the hook and loop sealing panel 8 being sewn to the base of the screen for sealing with complimentary fastenings on the access door panel when in closed mode.

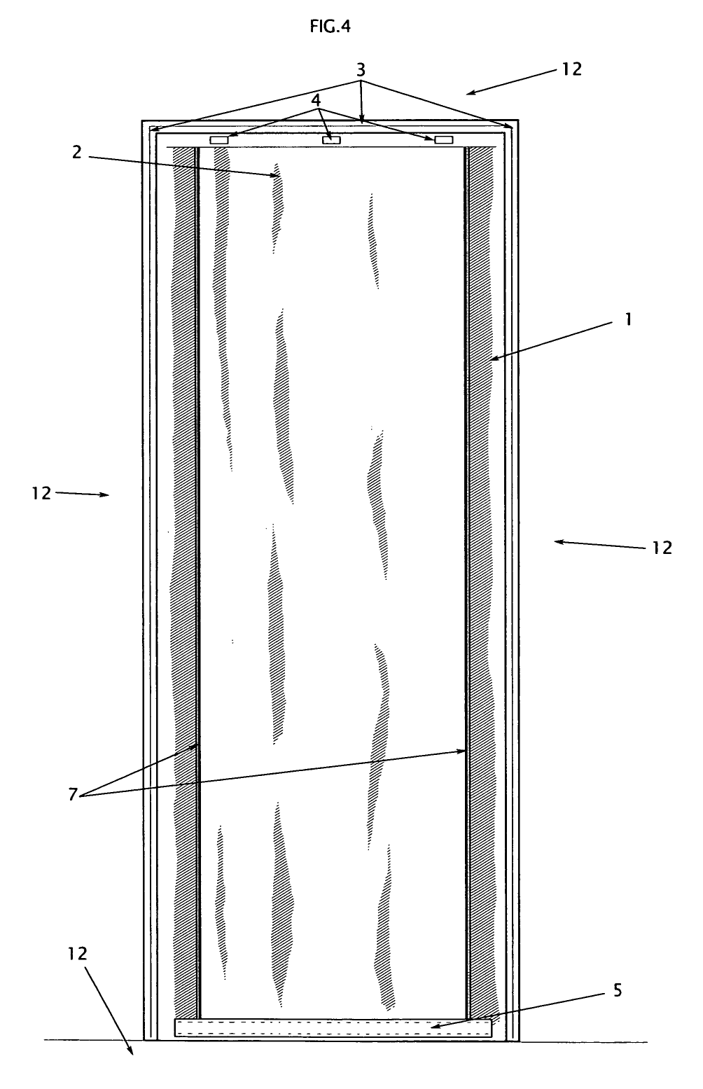

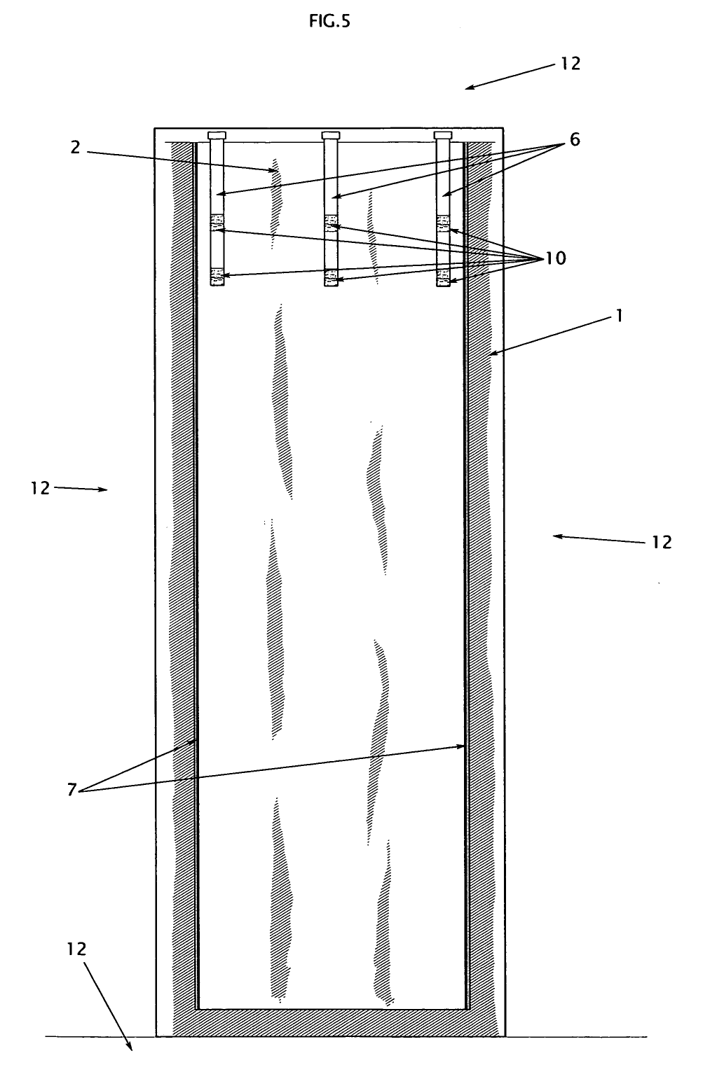

FIG. 4 depicts a preferred embodiment of the invention with a front view of the dust protection door sealed to the surround and the door access panel in closed mode. The perpendicular zip fasteners 7 are sealed and the hook and loop sealing panel 5 is sealed to the base hook and loop panel of the screen to prevent dust contamination in adjoining rooms. The screen being depicted 1 with the access panel depicted 2. Around the hemmed peripheral edges of the screen is depicted an adhesive tape 3 overlap aligned with the screens peripheral hem forming a seal to all sides of the surrounds 12. The drawing also depicts the retaining looped tabs which are sewn onto the screen 4 above the access panel which form part of the mechanism apparatus of retaining the straps when the door access panel is in use.

FIG. 5. Depicts a rear view through the aperture surrounds 12 of the dust protection door in closed mode. The screen being depicted 1 with the access panel depicted 2. The zip fasteners 7 and hook and loop fastenings are sealed to prevent dust contamination in adjoining rooms. The drawing also depicts the retaining straps 6 located and sewn on the rear of the screen with hook and loop tabs 10 sewn onto the straps tabs for securing the rolled access door as part of the retaining apparatus. The drawing also depicts the rear base of the screen which maintains a seal and provides walk through access when in the open mode.

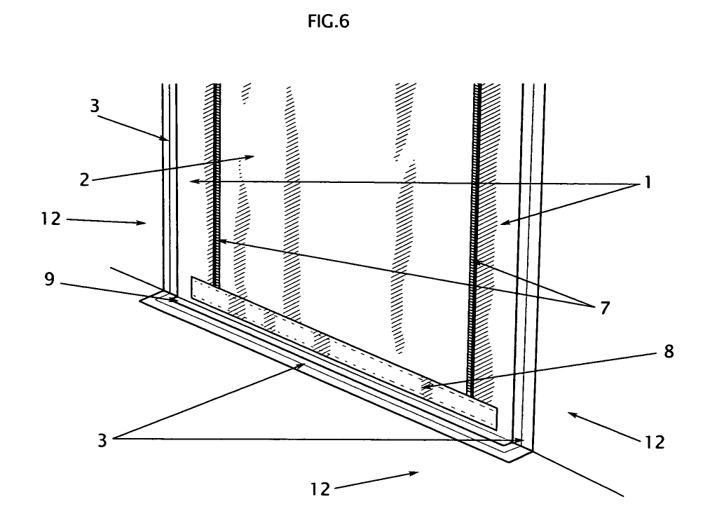

FIG. 6. Depicts a closer view of the base of the dust protection door in its closed mode maintaining a seal at the base and all sides of the surrounds 12. The sealing panel 5 is attached to complimentary parts of the hook and loop panel at the base of the screen. The screen being depicted 1 with the access panel being 2. The drawing discloses when 9 is folded along its second hem for its intended purpose, the base of the screen provides a sealing panel which lays flush with the base of the surround 12 and is secured with overlapping adhesive tape 3 aligned with the screens peripheral hem. The hemmed peripheral edges of the screen are also depicted sealed to the surrounds with adhesive tape 3 overlap aligned with the screens peripheral hem. The perpendicular inner edges of the screen are also depicted with double sided zip fastenings 7 in the closed fastened mode to prevent dust contamination in adjoining rooms.

In its preferred embodiment the invention provides eight varying convenient levels of access through combinations of use of the fastenings 1) left zip unzipped for access, 2) right zip unzipped for access, 3) left and right zips unzipped for access, 4) left zip unzipped together with hook & loop released from the base, 5) right zip unzipped together with hook & loop released from the base, 6) both left and right zips unzipped together with hook & loop released from the base, 7) hook & loop released from the base, 8) left and right zips unzipped together with hook & loop released from the base and door access panel rolled and stowed for full door access. All modes maintaining the base of the screens adhesive tape dust proof seal to the surrounds and all along the hemmed peripheral edge of the screen to the surrounds.

What is claimed is:

1. A dust screen which is mountable to the surround of a door or similar building aperture to prevent dust transfer, the screen being formed from a flexible dust-impermeable material and having a hemmed peripheral edge which is sealed to the door surround in use, and within which is defined a substantially rectangular flexible door panel forming a re-sealable access opening for entry or exit there through, the door panel having a first edge overlapping the base of the screen with a sealing panel which is releasably attached to an adjacent part of the screen material with hook and loop fastener, the door panel also having second and third edges which are each perpendicular and adjacent to the first edge and which are releasably attached to adjacent parts of the screen material by double sided zip fastenings.

2. A dust screen according to claim 1, in which the screen is made from dust impermeable fabric or plastic material, or a combination to these materials and is provided with a plurality of straps with hook and loop tabs to hold and retain the door access panel in the open position when all fasteners are unfastened and the door access panel is rolled up.

3. A dust screen according to any proceeding claim, in which the peripheral edge of the screen and the base of the screens sealing panel lay flush to the surround and is sealed to the door surround using adhesive tape or alike.
